(19) United States
(12) Patent Application Publication
(10) Pub. No.: US 2015/0002395 A1
(43) Pub. Date: Jan. 1, 2015

(54) Method of Interaction Between a Digital Object Representing at Least One Real or Virtual Object Located in a Distant Geographic Perimeter and a Local Pointing Device

(71) Applicant: Orange, Paris (FR)

(72) Inventors: Philippe Romano, Cagnes Sur Mer (FR); Vincent Giraudon, Antibes (FR); Adrien Bruno, Grasse (FR)

(21) Appl. No.: 14/316,553

(22) Filed: Jun. 26, 2014

(30) Foreign Application Priority Data
Jun. 27, 2013 (FR) 1356207

(51) Int. Cl. G06F 3/033

(52) U.S. Cl. CPC G06F 3/033
USPC 345/157

(57) ABSTRACT

A method of interaction between a digital object representing at least one real or virtual object located in a first geographical perimeter and a pointing device, used in a second geographical perimeter. A unit accesses a first data base referencing digital objects and memorizing a geographical position in the first geographical perimeter for each digital object. The method includes: setting up a communications channel between the unit and a tracking device capable of obtaining pointing information on the pointing device; receiving, pointing information representing a real orientation of the pointing device in the second geographical perimeter; and identifying, depending on the pointing information received and on a starting virtual position and a starting virtual orientation assigned to the pointing device in the first geographical perimeter, a digital object of the first geographical perimeter, the geographical position of which is virtually pointed at by the pointing device.

### 1. FIELD OF THE INVENTION

The field of the invention is that of geographical information systems (GIS) each associated with a geographical perimeter and comprising a unit (also called a central unit) accessing a data base. This data base references a plurality of digital objects and memorizes a position in the geographical perimeter for each of these digital objects. Each digital object represents at least one real or virtual object located in a geographical perimeter. Each digital object possesses an identifier and is defined in the data base by geometrical component defining a geographical position of the digital object in the geographical perimeter associated with the GIS and by a descriptive component defining at least one descriptive attribute. The unit is adapted to determining whether the position of one of the digital objects is pointed at by the given pointing device. It does this according to the positions of the digital objects in the geographical perimeter and on the basis of information on the position and orientation of a given pointing device.

More specifically, the invention pertains to a technique of interaction between at least one digital object representing at least one real or virtual object located in a distant geographical perimeter and a local pointing device used in a local geographical perimeter.

### 2. TECHNOLOGICAL BACKGROUND

An example of a geographical information system adapted for use with a pointing device is described in the French patent application filed on 29 Mar. 2012, under number FR1252873 on behalf of France Telecom.

In the application No. FR1252873, it is recalled that, in prior-art techniques, to determine whether a pointing device is pointing at (i.e. is directed towards) a target device (the device that is being pointed at). The pointing device and the device pointed at must be designed to work together (one has a sender and the other a receiver capable of detecting a signal sent by the sender). For example, a television set typically comprises an infrared receiver capable of receiving infrared signals sent by a remote control unit supplied with this television set.

The major drawback of these prior-art techniques is that a communications channel has to be set up (by means of the sender/receiver pair) between the pointing device and the device pointed at. This leads to the creation of manufacturer-specific hardware of low upgradability entailing its own multiplicities.

The technique proposed in the application FR1252873 (the operation of which is described in detail further below with reference to FIGS. 1 and 2) consists of the use of a central unit to determine which device or devices are pointed at by the pointing device. This technique thus provides several advantages as compared with the above-mentioned prior-art techniques. Indeed, it is the central unit that obtains a piece of 3D pointing information, i.e. a piece of information indicating those devices, pointed at, towards which the pointing device is physically oriented, in a 3D space. It is therefore not necessary for the pointing device and the device or devices pointed at to be designed to work together (there is no need for one device to have a sender and the other to have a receiver matching the sender). For the central unit, knowledge of the 3D pointing information makes it possible to create an association between the pointing device and the device or devices pointed at. It is possible to create applications resulting from this association (especially but not exclusively to control the device pointed at by the pointing device).

However, the technique of the application FR1252873 can be further improved in order to improve uses and interactions, especially remote interactions with a geographical information system (by using a pointing device that is not present in the geographical perimeter of this geographical information system).

### 3. SUMMARY OF THE INVENTION

One particular embodiment of the invention proposes a method of interaction between at least one digital object representing at least one real or virtual object located in a first geographical perimeter and a pointing device used in a second geographical parameter distinct from the first geographical parameter. A unit accesses a first data base referencing one or more digital objects and memorizing a geographical position in the first geographical perimeter for each of these digital objects. The method comprises the following steps:
setting up a first communications channel between the unit and a tracking device capable of obtaining pointing information on the pointing device;
receiving, by means of the unit, via the first communications channel, pointing information representing a real orientation of the pointing device in the second geographical perimeter;
identifying, by means of the unit, depending, on the one hand, on the pointing information received and, on the other hand, on a starting virtual position and a starting virtual orientation assigned to the pointing device in the first geographical perimeter, a digital object of the first geographical perimeter, the geographical position of which is virtually pointed at by the pointing device.

According to one particular characteristic, the method comprises the following steps:
transmission to the tracking device, via the first communications channel, of information on interactions relating to interactions available or performed on the identified digital object;
transmission by the tracking device to a control device (that coincides or does not coincide with the unit) via a second communications channel (that coincides or does not coincide with the first communications channel) of commands on interactions relating to interactions to be made on the identified digital object.

One particular embodiment of the invention proposes a method of interaction between at least one digital object representing at least one real or virtual object located in a remote geographical perimeter and a local pointing device used in a local geographical perimeter,

a remote unit accessing a remote data base referencing one or more digital objects and memorizing a position in the remote geographical perimeter for each of these digital objects, the remote unit being adapted to determining, according to the positions of the digital objects in the remote geographical perimeter and of information on the position and orientation of a given pointing device, whether the position of one of the digital objects is pointed at by the given pointing device,
the method comprising the following steps:
setting up a communications channel between the remote unit and the local tracking device capable of obtaining pointing information on the local pointing device;
receiving, by means of the remote unit, via the communications channel, of pointing information representing a real orientation of the local pointing device in the local geographical perimeter;
identifying, by means of the remote unit, depending firstly on the pointing information received and secondly on a starting virtual position and a starting virtual orientation assigned to the local pointing device in the remote geographical perimeter, a digital object of the remote geographical perimeter, the position of which is virtually pointed at by the local pointing device.

The general principle of the invention therefore consists in transmitting pointing information pertaining to the local pointing device to a remote unit (also called a central unit of a remote geographical information system or remote GIS). This enables the remote unit to determine whether the local pointing device is virtually pointing towards the position of one of the digital objects of the remote geographical perimeter. Thus, the user can make use of the local pointing device (not present in the remote geographical perimeter) to virtually point at the digital objects of this remote geographical perimeter as if it were at a determined position in the remote geographical perimeter.

The term “local tracking device” is understood to mean for example the pointing device or a local unit (also called a central unit of a local geographical information system or local GIS).

According to one particular characteristic, the method comprises the following steps:
transmission to the local tracking device, via the communications channel, of information on interactions, relating to interactions available or performed on the identified digital object; and
reception by the remote unit, via the communications channel, of interaction commands relating to interactions to be made on the identified digital object.

Thus, the user can make use of the local pointing device to interact with digital objects of the remote geographical perimeter, as if it were located at a determined position in the remote geographical perimeter.

According to one particular characteristic, a local data base references one or more digital objects representing real or virtual objects located in the local geographical perimeter and memorizes a position in the local geographical perimeter for each of these digital objects. Furthermore, the step for setting up the communications channel is activated by a detection of an event belonging to the group of events comprising:
the local pointing device points at the position of a particular digital object located in the local geographical perimeter, prompting an automatic activation of a function associated with said particular digital object;
a user, via a man-machine interface of the local pointing device, activates a function associated with a digital object that is located in the local geographical perimeter and the position of which is pointed at by the local pointing device;
a user, working via a man-machine interface of the local pointing device, activates a particular function associated with a digital object which is located in the remote geographical perimeter and is associated with a digital object located in the local geographical perimeter, and the position of which is pointed at by the local pointing device.

According to one particular characteristic, the step for setting up the (first) communications channel is triggered by detection of an event belonging to the group comprising the following events:
a user makes a particular gesture with a local pointing device;
a user uses a man-machine interface of the tracking device to execute a particular function;
a user uses a man-machine interface of the local pointing device to send a particular command to the tracking device;
a user uses a man-machine interface of the local pointing device to set up a connection with the tracking device.

According to one particular characteristic, the starting virtual position and/or the starting virtual orientation are:
predetermined and stored in the remote unit; or
computed as a function of the characteristics of the remote geographical perimeter; or
determined relatively to a digital object of the remote geographical perimeter; or
chosen by a user via a man-machine interface.

According to one particular characteristic, the method comprises a step for providing a user, via a man-machine interface of the local pointing device, with guidance information on a current virtual position and a current orientation determined for the local pointing device in the remote geographical perimeter.

Thus, the user is guided in the virtual orientation within the remote geographical perimeter of the local pointing device. The pieces of guiding information are provided for example in the form of a spatialized sound or of a graphic modeling.

According to one particular characteristic, the method comprises a step for creating at least one group of associated digital objects, each group associating at least one digital object of the local geographical perimeter with at least one digital object of the remote geographical perimeter.

In this way, digital objects of the local geographical perimeter can cooperate with digital objects of the remote geographical perimeter. Thus, the notion of association between two digital objects, described for two digital objects of a same GIS in the French patent application filed on behalf of France Telecom on 21 Dec. 2012 under number FR1262596, is generalized.

According to one particular characteristic, the method comprises a step for creating a new digital object of the remote geographical perimeter.

Another embodiment of the invention proposes a computer program product that comprises program code instructions for implementing the above-mentioned method (in any one of its different embodiments) when said program is executed on a computer.

Another embodiment of the invention proposes a computer-readable and non-transient storage medium storing a computer program comprising a set of instructions executable by a computer to implement the above-mentioned method (in any one of its different embodiments).

Another embodiment of the invention proposes a remote unit for implementing a method of interaction between at least one digital object, representing at least one real or virtual object located in a remote geographical perimeter and a local pointing device, used in a local geographical perimeter. The remote unit accesses a remote data base referencing one or more digital objects and memorizing a position in the remote geographical perimeter for each of these digital objects. The remote unit is adapted to determining whether the position of one of the digital objects is being pointed at the given pointing device, according to the positions of the digital objects in the remote geographical perimeter and from information on the position and orientation of a given pointing device. The remote unit comprises:
means for setting up a communications channel with a local tracking device, capable of obtaining information on pointing of the local pointing device;
means for receiving, via the communications channel, pointing information representing a real orientation of the local pointing device in the local geographical perimeter;
means for identifying, as a function firstly of received pointing information and secondly of a starting virtual position and a starting virtual orientation assigned to the local pointing device in the remote geographical perimeter, a digital object of the remote geographical perimeter, the position of which is pointed at virtually by the local pointing device.

According to one particular characteristic, the remote unit comprises:
means of transmission to the local tracking device, via the communications channel, of information on interactions relative to available interactions or interactions made on the identified digital object; and
means of reception, via the communications channel, of interaction commands relating to interactions to be made on the digital object identified.

Advantageously, the central unit of the remote geographical information system comprises means for implementing steps that it performs in the method as described here above in any one of its different embodiments.

Another embodiment of the invention proposes a unit for implementing a method of interaction between at least one digital object, representing at least one real or virtual object located in a first geographical perimeter, and a pointing device, used in a second geographical perimeter distinct from the first geographical perimeter. The unit accesses a first data base referencing one or more digital objects and memorizing a position in the first geographical perimeter for each of these digital objects, the unit being adapted to determining whether the position of one of the digital objects is being pointed at the given pointing device, according to the positions of the digital objects in the first geographical perimeter and from information on the position and orientation of a given pointing device, the unit comprising:
means for setting up a communications channel with a tracking device, capable of obtaining information on pointing of the pointing device;
means for receiving, via the communications channel, pointing information representing a real orientation of the pointing device in the second geographical perimeter;

means for identifying, as a function firstly of received pointing information and secondly of a starting virtual position and a starting virtual orientation assigned to the pointing device in the first geographical perimeter, a digital object of the first geographical perimeter, the position of which is pointed at virtually by the local pointing device.

### 4. LIST OF FIGURES

Other features and advantages of the invention shall appear from the following description, given by way of an indicative and non-exhaustive example, and from the appended drawings, of which:

FIG. 1 is a block diagram illustrating a mechanism for managing the pointing of a pointing device at a target device by means of a geographical information system according to the technique of the application FR1252873;

FIG. 2 is a flowchart illustrating the algorithm executed by the geographical information system in the mechanism for managing the pointing illustrated in FIG. 1 (technique of the application FR1252873);

FIGS. 3 and 3a present the structure of a local pointing device and a central unit, respectively, according to one particular embodiment of the invention;

FIG. 4 is a flow chart of a particular embodiment of the method according to the invention;

FIG. 5 illustrates a first implementation of the technique of the invention with the setting up of a communications channel between the central unit of a local GIS and the central unit of a remote GIS;

FIG. 6 illustrates a second implementation of the technique of the invention with the setting up of a communications channel between the pointing device and the central unit of a remote GIS;

FIGS. 7a to 7f illustrate the results of successive steps of the flow chart of FIG. 4 through a first example (corresponding to the first implementation illustrated in FIG. 5);

FIGS. 8a to 8d illustrate the result of the successive steps of the flow chart of FIG. 4 through a second example (corresponding to the second implementation described with reference to FIG. 6);

FIG. 9 illustrates a third implementation of the technique of the invention;

FIG. 10 illustrates a fourth implementation of the technique of the invention.

### 5. DETAILED DESCRIPTION

In all the figures of the present document, the identical elements and steps are designated by a same numerical reference.

### 5.1 Reminder of the Technique of the Patent Application FR1252873

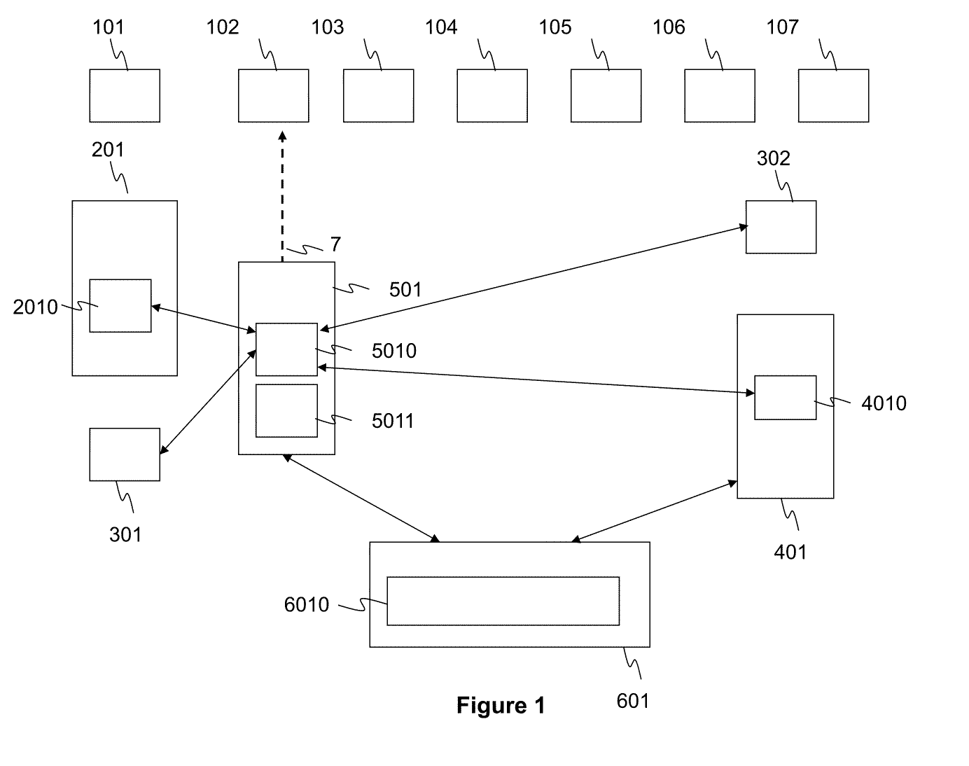

Referring now to FIG. 1, we present a mechanism to manage the pointing of a pointing device at a target device (real object) by means of a geographical information system (GIS) according to the technique of the patent application FR1252873.

In this example, the system comprises:
apparatuses 101 to 107 (for example a door 101, a video projector 102, a shutter apparatus 103, a decoder 104, a LAN IP network device 105, an IP printer 106, a private branch exchange (PBX) 107, . . . ), which embed no locating module;
apparatuses 301, 302 which are solely locating modules;
apparatuses 201, 401 (for example a television set 201 and a network apparatus (router, gateway, decoder) 401) which embed a locating module 2010, 4010 by which their positions can be determined (automatically, by computation using the central unit 601);
apparatuses (for the sake of simplicity in FIG. 1, only one apparatus referenced 501, is represented therein) which are mobile terminals (smartphones, tablets, laptops, magic wands, toys, etc) which embed a locating module 5010, as well as several sensors 5011 (accelerometers, gyroscopes, compasses, etc.) by which their orientation in a 3D space can be deduced;
a central unit (also called a computer) 601 which aggregates, computes and handles the information (especially information on position) relating to the other above-mentioned apparatuses 101 to 107, 201, 301, 302, 401, 501 and to the environmental and time-related data (drawings, diagrams, etc.). All these pieces of data are stored in a data base 6010 here below called a “GIS data base” (the acronym GIS meaning geographical information system). The GIS data base 6010 also has a 2D and/or 3D plane representation of the buildings or the geographical zone in which all the apparatuses are situated.

The central unit 601 is for example connected to a network (local LAN or remote WAN as in a Cloud-type solution), by means of the network apparatus 401. In one variant, the central unit 601 is integrated into the network apparatus 401. The central unit 601 can automatically complement and/or update its GIS data base 6010. An administrator can also add or modify the data of the GIS data base.

In one particular implementation, the locating modes 2010, 301, 302, 4010, 5010 are ultra-large-band (ULB) locating modules or ultra-wide-band (UWB) locating modules. They form a geo-location network to determine the distances between locating modules by using flight-time measurements. As soon as they are sufficient in number, it becomes possible to determine the position of each the other locating modules by triangulation: using measurements of angles or measurements of relative distances. The locating modules are independent. They can detect and/or report their presence to neighboring modules (within signal range) and inform the central unit 601 thereof.

In the example of FIG. 1, the positions (3D x, y, z coordinates) of the apparatuses 301, 302 (which are solely locating modules) are known (reference positions) and stored in the GIS data base of the central unit 601.

Through the locating modules 2010, 4010 embedded in the apparatuses 201, 401, the positions of these apparatuses are computed automatically by the central unit 601 and stored in its GIS data base.

Thus, knowledge of the positions of the apparatus 201, 301, 302, 401 installed in known reference positions is used to determine the position of each of the mobile terminals 501 (by triangulation computations). For example, the locating module 5010 included in the mobile terminal 501 communicates with the locating modules of the apparatuses 201, 301, 302, 401 placed at known positions. This makes it possible to determine the distances between the locating module 5010 and the locating modules of the apparatuses 201, 301, 302, 401. Then, the central unit 601 obtains these distances (they are transmitted to it by the mobile terminal 501 and/or by at least one of the terminals 201, 301, 302, 401). Finally, the central unit 601 determines the position of the mobile terminal 501 by triangulation according to the above-mentioned distances and the known positions of the locating modules embedded in the apparatuses 201, 301, 302, 401. To this end, a communications link is set up between, firstly, the central unit 601 and, secondly, the mobile terminal 501 and/or the apparatuses 201, 301, 302. This link uses for example a local WiFi network or any other network which are accessed by the mobile terminal 501 and/or the apparatuses 201, 301, 302.

Thus, the central unit 601 can carry out real-time tracking of the movements of all the mobile terminals (especially the one referenced 501 in FIG. 1) that have a locating module. The central unit 601 takes account of the time dimension because the apparatuses (especially the mobile terminals) can be in motion. The central unit 601 is capable of managing several pointing devices simultaneously.

All the positions (3D x, y, z coordinates) of the apparatuses 101 to 107 (that do not include any locating module) are known and stored in the GIS data base 6010 of the central unit 601.

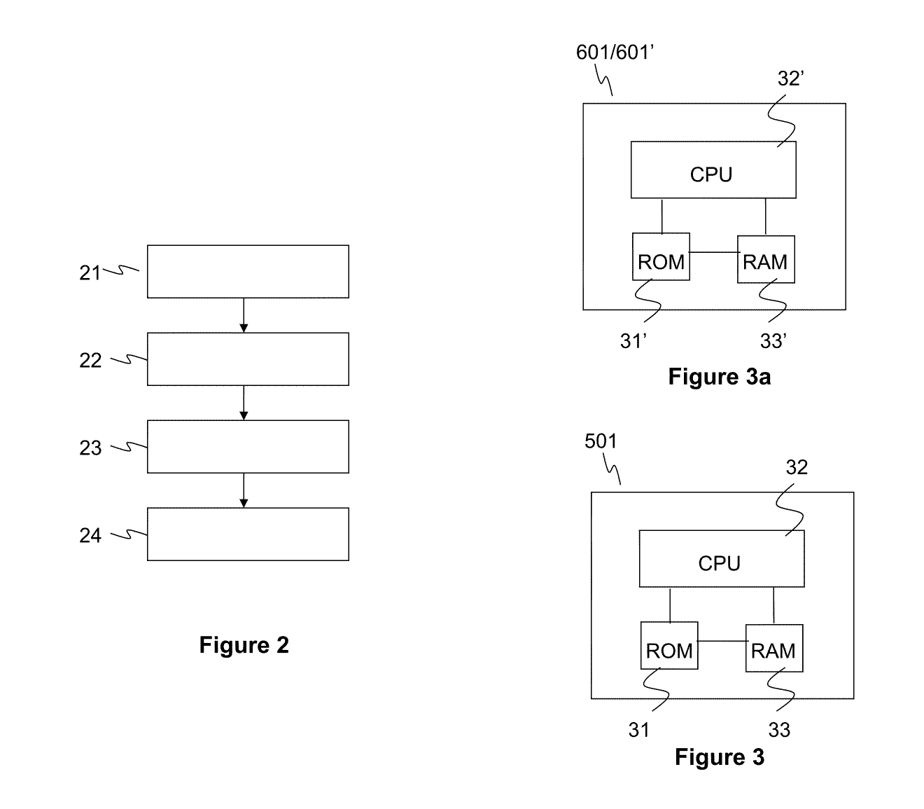

Referring now to the flow chart of FIG. 2, we present the algorithm executed by the central unit (computer) 601 of the geographical information system in the mechanism for managing pointing illustrated in FIG. 1 (technique according to the patent application FR1252873).

It is sought to determine that apparatus or those apparatuses of the system to which the user is directing a pointing device, i.e. the apparatus or apparatuses pointed at by the pointing device. The user is to be offered a simple and natural way of designating the apparatuses with which he wishes to interact.

By way of an illustratory example, it is assumed here below in the description that the pointing device is the mobile terminal 501 and that the user is pointing it towards the video projector 502. The axis of rotation of the pointing device is symbolized by the arrow of dashes referenced 7 in FIG. 1.

In a step 21, the central unit 601 obtains a piece of information on the position of the mobile terminal 501 (pointing device). As explained here above (see FIG. 1), using the apparatuses 201, 301, 302, 401, the position of the mobile terminal 501 is known and tracked in real time by the central unit 601 which centralizes all the information in its GIS data base 6010.

In a step 22, the central unit 601 obtains a piece of information on the orientation of the mobile terminal 501. As explained here above (see FIG. 1), the mobile terminal 501 has one or more sensors (accelerometers, gyroscopes, compasses, etc.) by which it can deduce its orientation and transmit this piece of information on orientation to the computer 601.

In a step 23, the central unit 601 obtains a piece of information on the position of the apparatuses 101 to 107, 201, 301, 302, 401 (target devices). As explained here above (see FIG. 1), this is done by reading the content of the GIS data base 6010 of the central unit 601.

In a step 24, the central unit 601 determines the apparatus or the group of apparatuses pointed at by the mobile terminal 501 as a function of:
the information on the position of the mobile terminal 501;
the information on the orientation of the mobile terminal 501; and
the information on the positions of the other apparatuses 101 to 107, 201, 301, 302, 401.

It is enough for the user to change the orientation and/or the position of the mobile terminal 501 to designate one or more new targets (apparatuses pointed at).

Thus, according to the proposed technique, the position and orientation in space of the mobile terminal 501 (pointing device) coupled with the positions of the other apparatuses (through the computer 601) are enough to determine the apparatuses being pointed at by the mobile terminal 501. Depending on the applications, the association between the mobile terminal 501 (pointing device) and the apparatuses being pointed at can be used in various ways. In particular, but not exclusively, the mobile terminal 501 can control an apparatus that is being pointed at. It can do so via the central unit 601 (hence without direct communication between the pointing device and the device pointed at).

### 5.2 General Principle of the Proposed Technique

A technique is proposed for interaction between a remote geographical information system (here below called a remote system or remote GIS) and a local pointing device (used in a local geographical perimeter), the latter being used or not used with a local geographical information system (here below called a local system or local GIS).

Each geographical information system (local or remote) is associated with a geographical perimeter and comprises a central unit accessing a data base (also called a “GIS data base” here below) referencing digital objects and memorizing a position in this geographical perimeter. Each digital object is a set of pieces of data/information representing an object, real or virtual, located n this geographical perimeter. Each digital object is defined in the data base by:
an identifier;
a geometrical component defining a geographical position of the object (real or virtual) represented by this digital object (for example the geometrical component is defined by the position of a single point, or else by the position of a plurality of points forming a line and defining a surface); and
a descriptive component defining at least one descriptive attribute of the digital object (also called a “property of the digital object”).

The term “attributes of a digital object” is understood to mean for example:
functions (also called “actions” or again “interactions”) executable by the central unit, the pointing device or the device pointed at (examples: a function for activating the linking of two geographical information systems, functions enabling action on a real object, the digital object of which is a representation, etc);
multimedia objects (virtual memos, virtual table (for these virtual memos), videos, photos, etc), and associated functions (for example play, pause, stop, etc) enabling action on these multimedia objects;
links (for example URL addresses or local addresses) enabling access to multimedia objects;
etc.

As in the technique of the application FR1252873 (or by means of an alternative technique), the central unit is adapted to determining whether the position of one of the digital objects is pointed at by the given pointing device, in doing so as a function of the positions (geometrical components) of the digital objects in the remote geographical perimeter and information on the position and orientation of a given pointing device. In other words, the invention uses the pointing management technique described in the application FR1252873, or an equivalent technique.

The invention distinguishes for example two categories of digital objects in the GIS data base 6010 (only the first category is mentioned in the application FR1252873).

First category: digital objects representing (i.e. objects that are models of) real objects of the environment in which the geographical information system is implemented. For example, for a refrigerator which is a real object, it is possible to create and store, in the GIS data base 6010, a “refrigerator” digital object whose geometrical component defines the geographical position of the refrigerator. More generally, the real objects considered (i.e. objects whose models are contained in the GIS data base 6010) can be of any nature: real objects with which it is possible to interact through the central unit and/or the given pointing device, or else real objects which cannot be interacted with through the central unit and/or the given pointing device).

Second category: digital objects representing purely virtual digital objects, i.e. digital objects whose geometrical component defines a geographical position independently of the presence or non-presence of a real object at this geographical position. In other words, these are digital objects resulting from the modeling of a real object of the environment in which the geographical information system is implemented. The digital objects representing purely virtual objects possess a descriptive component defining one or more attributes such as, for example:
functions (also called “actions” or again “interactions”) executable by the central unit, the pointing device or the device pointed at;
multimedia objects (virtual memos, virtual table (for these virtual memos), videos, photos, etc); or
links (for example URL addresses or local addresses) enabling access to multimedia objects stored in other units (for example remote servers or local storage devices).

The use of these digital objects representing purely virtual objects is for example the following: if the position of a digital object representing a purely virtual object is pointed at by an pointing device, the central unit enables an pointing device to carry out the action or actions listed in the descriptive component of this digital object (these are also referred to as actions associated with this digital object).

FIG. 5 illustrates a first implementation of the technique of the invention in which the local pointing device 501 is used with a local tracking device which is the central unit 601 of the local system, as in the context of FIG. 1. In this first implementation, a communications channel 51 is set up between the central unit 601 of the local system (which accesses a local data base 6010) and the central unit 601′ of the remote system (which accesses a remote data base 6010′). Thus, in the context of a personal or professional environment equipped with a (local) geographical information system (local) and a (local) pointing device, the first implementation of the proposed technique makes it possible to extend the capacities of pointing and interaction with another (remote) geographical information system. The user can make use of the pointing device to act as if he were at a determined position in the perimeter of the remote geographical information system, to point there at digital objects (representing real or virtual objects) of the environment and thus interact with them, and to make them participate in a more general interaction with digital objects of the local geographical information system (also representing real or virtual objects).

FIG. 6 illustrates a second implementation of the technique of the invention in which the local pointing device 501 is not used with the central unit 601 of the local system, unlike in the context of FIG. 1. In this second implementation, a communications channel 61 is directly established between the local pointing device 501 (which in this case is the local tracking device) and the central unit 601′ of the remote system (which accesses a remote data base 6010′). Indeed, to point remotely through the communications channel 51, it is not necessary for the local pointing device 501 to be geo-located in a geographical perimeter of the local system. Only the pointing gestures and the interaction actions (it is assumed that the local pointing device 501 is capable of obtaining them) must be transmitted to the central unit 601′ of the remote system via the communications channel 61.

In short, and as described in detail here below, whatever the (first or second) implementation adopted, the communications channel 51 or 61 enables a user to make use of the local pointing device 501 (although he is not present in the geographical perimeter of the remote system) to point virtually at digital objects of this remote system. In other words, the user acts as if he were (with the local pointing device that he manipulates) at a determined distance (precise but nevertheless configurable) in the geographical perimeter of the remote system, to therein point at digital objects (representing real or virtual objects) of this environment and thus interact with them.

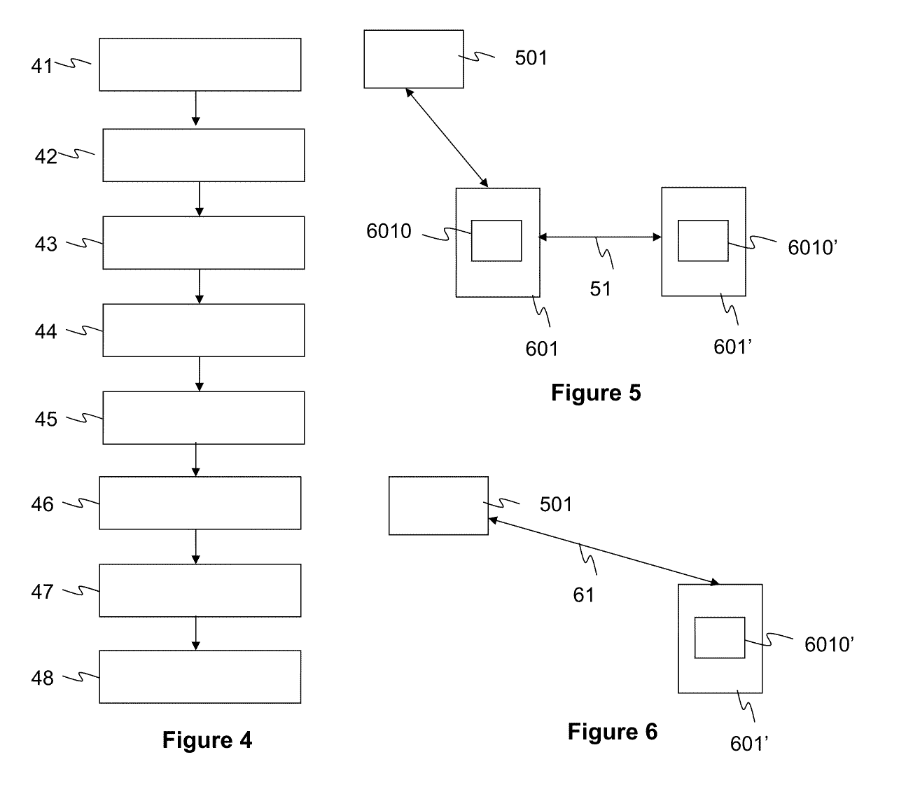

FIG. 4 is a flowchart of a particular embodiment of the method according to the invention.

The step 41 is a step for configuring each geographical information system including the creation of associations between digital objects of the local system (or of local context if the local pointing is not used with the local system) and digital objects of the remote system.

More specifically, in the case of the first implementation illustrated in FIG. 5, the main elements of configuration are: for each GIS system:
the creation of associations between the digital objects of this GIS system and other GIS systems (for example according to needs expressed by the user);
the definition of a starting virtual position (see paragraph 5.8 here below for the modification of this starting virtual position, i.e. the position of the pointing device in the remote system) and a starting virtual orientation (to enable the pointing at the digital objects of this GIS system from other GIS systems).

The step 42 is a step for setting up a linkage between two entities:
a local entity, namely the central unit 601 of the local system (the case of FIG. 5) or else the local pointing device 501 (the case of FIG. 6), and
a remote entity, namely the central unit 601′ of the remote system.

The communications channel 51 or 61 is set up between the two entities. The two entities exchange data on connection, identification and securing of the communications channels. They also exchange all information enabling the implementing of the following steps. They exchange for example data for identifying the local pointing device 501 (or each of the local pointing devices 501 if there are several devices concerned), as well as data on virtual positioning (starting virtual position and starting virtual orientation, predetermined or chosen in the configuration step 41) of the local pointing device 501 in the geographical perimeter of the remote system.

The step for setting up a linkage (step 42) can be initiated (triggered) in various ways. It is for example triggered by a detection of any one of the following events:
the central unit 601 of the local system detects that the local pointing device 501 is pointing at the position of a particular digital object of the local system (i.e. a digital object located in the local geographical perimeter), prompting an automatic activation of a particular function forming part of the attributes of the particular digital object (i.e. a function associated with the particular digital object);
the central unit 601 of the local system detects that a user, via a man-machine interface of the local pointing device 501, is activating a particular function forming part of the attributes of a digital object whose position is pointed at by the local pointing device (i.e. a function associated with this digital object);
the central unit 601 of the local system detects that a user, via a man-machine interface of the local pointing device 501, is activating a particular function associated with (i.e. forming part of the attributes of) a digital object of the remote system (i.e. an object located in the remote geographical perimeter) and associated with a digital object located in the local geographical perimeter, and the position of which is pointed at by the local pointing device;
the central unit 601 of the local system detects that a user is making a particular gesture with the local pointing device 501 (this particular gesture is configured to be attached to this function of activating the setting up of linkage);
a user (including the particular case of an administrator) uses a man-machine interface of the central unit 601 of the local system to execute a particular function;
a user (possessing the adequate privileges) uses a man-machine interface of the local pointing device 501 to send a particular command to the central unit 601 of the local system or to directly launch a connection with the central unit 601 of the local system. In this case, it is assumed for example that the user has the adequate privileges as well as the appropriate application and interface enabling him to drive and operate the setting up of a linkage directly from the local pointing device 501 which is for example a mobile terminal. This driving can be done through an embedded application or else by dialing the telephone number of the central unit 601′ of the remote system and calling it (which implies that the intelligence of the network and the central unit 601′ of the remote system enable connection by telephone calls);
a user uses a read application included in the local pointing device 501 to read the 2D barcodes (for example of the “QRcode” or “Datamatrix” type) or an electronic tag (for example of the “NFC tag” type) triggering the dispatch of a particular command to the central unit 601 of the local system and the direct launching of a connection with the central application 601 of the local system (the setting up of a linkage is activated by taking account of and automatically managing all the parameters contained in the code read or the label read);
etc.

The step 42 for setting up a linkage is followed by a step of remote pointing and interaction (comprising the steps 43 to 47), itself followed by a step 48 of disconnection (end of the setting up of the linkage between the two entities).

At the step 43, the central unit 601′ of the remote system receives, via the communications channel and from the central unit 601 of the local system (the case of FIG. 5) or of the local pointing device 501 (the case of FIG. 6), information on pointing pertaining to a real orientation of the local pointing device 501.

At the step 44, the central unit 601′ of the remote system identifies a digital object of the remote geographical perimeter, the position of which is virtually pointed at by the local pointing device 501. This identification is done as a function firstly of the pointing information (received at the step 43) and secondly of a starting virtual position and a starting virtual orientation assigned to the local pointing device 501 in the remote geographical perimeter.

The starting virtual position and starting virtual orientation can be:
predetermined and stored in the central unit of the remote system (they are for example defined in advance and configured in the central unit of each system, in using a software interface);
computed according to the characteristics of the remote system. The central unit 601′ of the remote system determines the most “comfortable” position or best “performing” position in order to enable an optimum use of the local pointing device 501. For example, it is from this position that it is possible to point most rapidly towards a large number of digital objects;
chosen by a user via a man-machine interface;
determined in relation to a digital object of the remote geographical perimeter, the position of which is permanently known and which, optionally, possesses the capacity to move (a radio-controlled vehicle for example).

At the step 45, the central unit 601′ of the remote system transmits interaction information to the central unit 601 of the local system (the case of FIG. 5) or to the local pointing device 501 (the case of FIG. 6), via the communications channel, this interaction information pertaining to interactions available or performed on the digital object identified at the step 44 (i.e. the digital object whose position is virtually pointed at by the local pointing device 501).

At the step 46, the central unit 601 of the local system (the case of FIG. 5) or the local pointing device 501 (the case of FIG. 6) transmits interaction commands to the central unit 601′ of the remote system, via the communications channel, these interaction commands pertaining to the interactions to be made on the digital object identified at the step 44.

At the step 47, the user receives, via a man-machine interface of the local pointing device 501, guidance information on a current virtual position and a current virtual orientation of the local pointing device 501 in the geographical perimeter of the remote system.

For example, the guiding of the user in the remote system can be done from a 3D spatialized sound. Using headphones connected to the local pointing device, it is possible to emit a sound positioned in the 3D space which could help a user to orient his local pointing device and thus making it possible to “await a digital object” (i.e. point towards the zone associated with this digital object, representing a real or virtual object) in the remote system where this user has just virtually teleported himself.

In one variant, the operator of the local pointing device can also retrieve a graphic model on a man-machine interface (MMI) of the geographical perimeter of the remote system. This graphic modeling is animated or permanently updated in response to pointing and orientation gestures which are performed with the local pointing device.

In one particular embodiment, the user can point at a digital object in the remote system, capture it and/or retrieve an attribute (also called a characteristic, property or function) to it, and to apply to it a digital object of the perimeter of the local system (in which the user is physically present).

### 5.3 First Example of Implementation

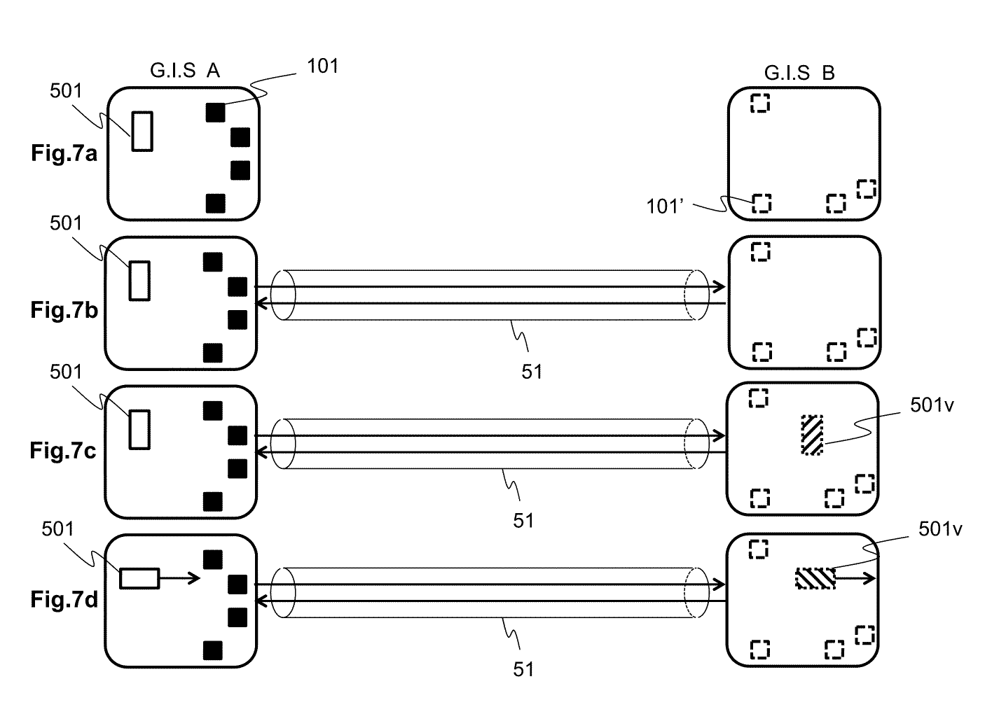

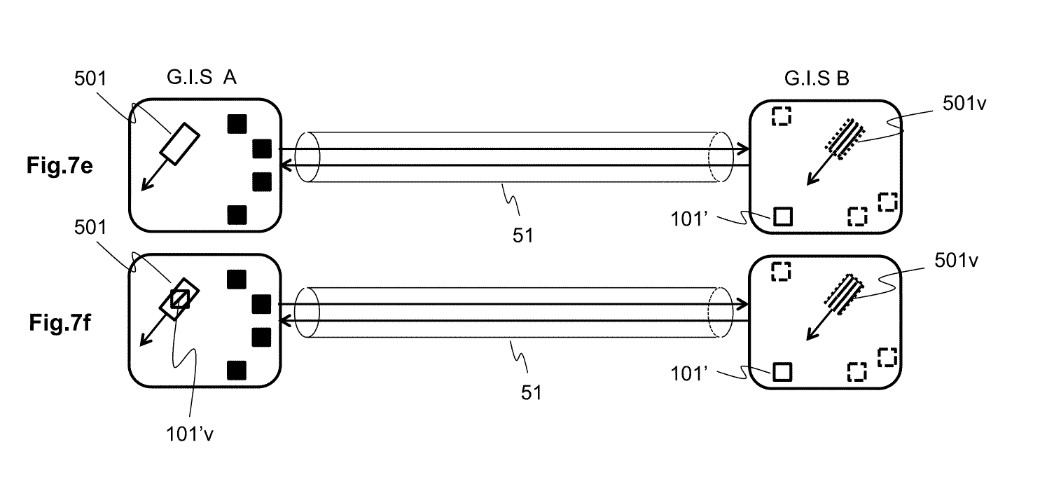

FIGS. 7a to 7f illustrate the result of the successive steps of the flowchart of FIG. 4 through a first example (corresponding to the first implementation illustrated in FIG. 5).

In each of these figures, the left-hand part of the figure schematically represents the local system (referenced GISA) and the right-hand part of the figure schematically represents the remote system (referenced GISB). The communication channel is referenced 51. The local pointing device present in the geographical perimeter of the GISA local system is referenced 501. The digital objects of the local system are represented by black squares (as an example one of them is referenced 101). The digital objects of the remote system are represented by white squares in dots and dashes (as an example, one of them is referenced 101′).

Each system (local or remote) comprises several elements in its perimeter (which are not all represented in the figures for the sake of simplification): a central unit, network units (router, gateway, decoders, etc), locating modules, one or more pointing devices, digital objects referenced in a data base and representing real objects (television sets, printers, video projectors, computers, sensors or home automation actuators) or virtual objects (butterfly stickers or post-its for example).

FIG. 7a illustrates a state preceding the performance of the step 42: the setting up of a linkage of the local system GISA with the remote system GISB has not yet been done.

FIG. 7b illustrates the start of the step 42 with the setting up (opening) of the communications channel 51 between the local system GISA and the remote system GISB, for example through various network units and by using standardized protocols of Ethernet and of the telecommunications world.

FIG. 7c illustrates the end of the step 42 with an exchange of different data, connection data, identification data, data for securing the communications channel, data for identifying the local pointing device 501, virtual positioning data (starting virtual position and starting virtual orientation) of the local pointing device 501 in the remote geographical perimeter (i.e. the geographical perimeter of the remote system). Thus, the local pointing device 501 is virtually in the remote geographical perimeter and this virtual representation is illustrated by the hatched rectangle referenced 501v.

FIG. 7d illustrates the step 43 in which the central unit 601 of the local system transmits pointing information to the central unit 601′ of the remote system, via the communications channel, this pointing information pertaining to a real orientation of the local pointing device 501. Thus, it can be seen in FIG. 7d that the local pointing device 501 and its virtual representation 501v are oriented identically (they therefore point in the same direction).

FIG. 7e illustrates the step 44 in which the central unit 601′ of the remote system identifies a digital object of the remote geographical perimeter, the position of which is pointed at virtually by the local pointing device 501. Thus, FIG. 7e shows that the virtual representation 501v of the local pointing system 501 points towards the digital object 101′ of the remote system. In other words, the local pointing device 501, although present in the perimeter of the local system, points virtually towards the digital object 101′ of the remote system.

FIG. 7f illustrates the steps 45, 46 and 47 in which the central unit 601′ of the remote system transmits interaction information (on the interactions available or carried out on the digital object, the position of which is virtually pointed at by the local pointing device 501) and receives interaction commands (pertaining to interactions to be made on the digital object whose position is pointed at virtually by the local pointing device 501). In addition, the receiver, through a man-machine interface of the local pointing device 501, receives guidance information on a current virtual position and a current virtual orientation of the local pointing device 501 in the remote geographical perimeter. Thus, in FIG. 7f, the hashed square referenced 101′v (virtual representation of the digital object 101′), placed on the local pointing device 501, symbolizes the fact that this local pointing device 501 is interacting with the digital object 101′ of the remote system.

It may be recalled that during the steps 43 to 47, there is a permanent exchange of information and data (pointing information, interaction information, interaction commands, guidance commands, etc) offering the user the possibility of detecting (perceiving), pointing (designating) and interacting with digital objects of the remote geographical perimeter.

### 5.4 Second Example of Implementation

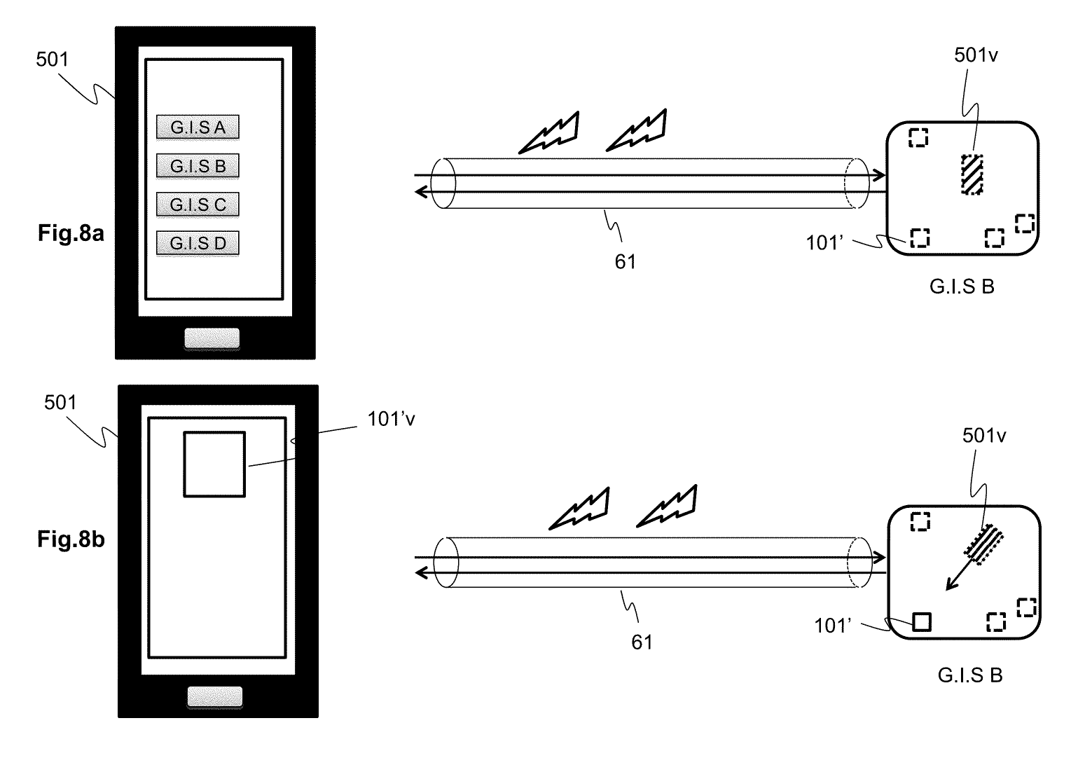

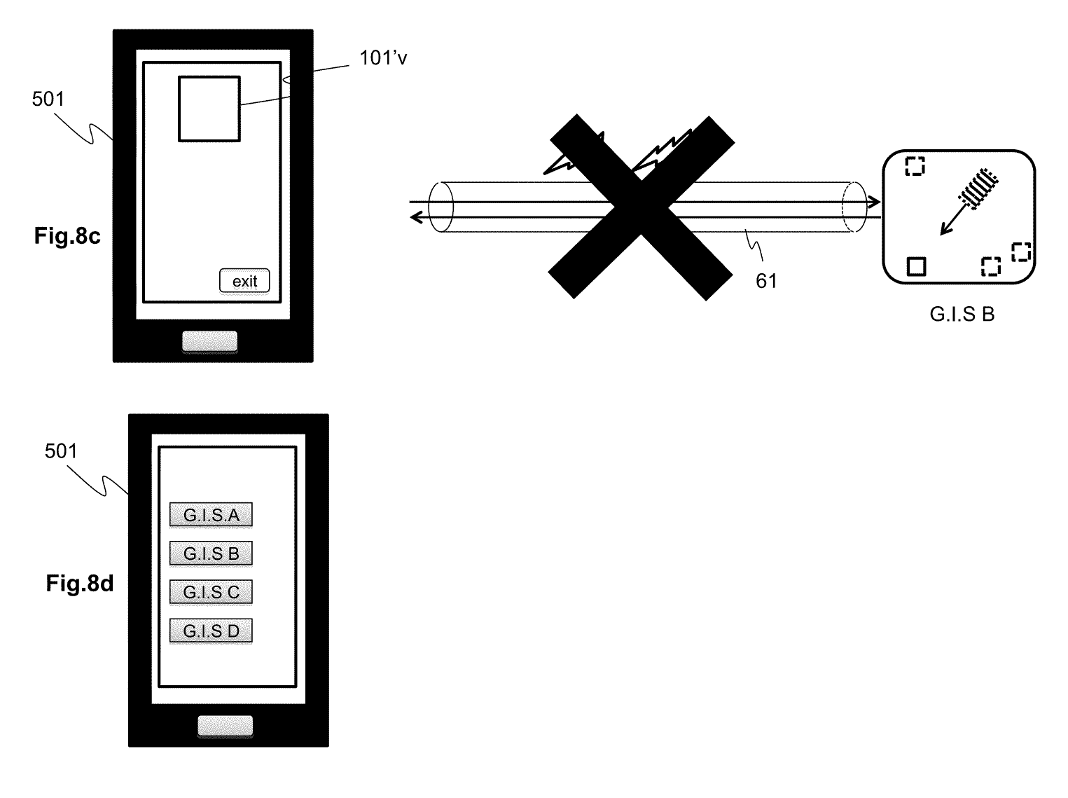

FIGS. 8a to 8d illustrate the result of the successive steps of the flowchart of FIG. 4 through a second example (corresponding to the second implementation illustrated in FIG. 6).

In each of these figures, the left-hand part of the figure schematically represents the local pointing device (referenced 501) and the right-hand part of the figure schematically represents the remote system (referenced GISB). The communications channel is referenced 61. The digital objects of the remote system are represented by blank squares in dots and dashes (for example one of them is referenced 101′).

The remote system comprises various elements in its perimeter (which are not all represented in the figures for the sake of simplification): a central unit, a network units (router, gateway, decoders, etc), locating modules, one or more pointing devices, digital objects referenced in a data base and representing real objects (television sets, printers, video projectors, computers, sensors or home automation actuators) or virtual objects.

It is assumed that the local pointing device 501 carries out a mobile application used to access different remote systems (symbolized by rectangles referenced GISA, GISB, GISC and GISD, and that the user has selected the remote site GISB.

FIG. 8a illustrates the step 42 with the establishing (opening) of the communications channel 61 between the local pointing device 501 and the remote system GISB, for example through various network units and by using standardized radio communications protocols (4G, WiFi, 3G, UMTS, etc). It also illustrates an exchange of different data: connection data, identification data, data for securing the communications channel, data for identifying the local pointing device 501, virtual positioning data (starting virtual position and starting virtual orientation) of the local pointing device 501 in the geographical perimeter of the remote system. Thus, the local pointing device 501 is virtually in the geographical perimeter of the remote system and this virtual illustration is represented by the hatched rectangle referenced 501v.

FIG. 8b illustrates the steps 43 to 47, in which:
the local pointing device 501 transmits pointing information to the central unit 601′ of the remote system via the communications channel, this pointing information pertaining to a real orientation of the local pointing device 501;
the central unit 601′ of the remote system identifies a digital object of the remote geographical perimeter, the position of which is pointed at virtually by the local pointing device 501. Thus, FIG. 8b shows that the virtual representation 501v of the local pointing device 501 points towards the digital object 101′ of the remote system;
the local pointing device 501 transmits interaction information (pertaining to interactions available of performed on the identified digital object, i.e. the digital object whose position is pointed at virtually by the local pointing device 501) and receives interaction commands (pertaining to interactions to be performed on the identified digital object). Furthermore, the user receives, via a man-machine interface of the local pointing device 501, guidance information pertaining to a current virtual position and a current virtual orientation of the local pointing device 501 in the geographical perimeter of the remote system. Thus, in FIG. 8b, the hashed square referenced 101′v (virtual representation of the object 101′) displayed on the screen of the local pointing device 501, symbolizes the fact that this device interacts with the digital object 101′ of the remote system.

FIG. 8c illustrates the de-connection step 48 and FIG. 8d illustrates the return to the original context (menu offering access to the different remote systems GISA, GISB, GISC and GISD).

### 5.5 Structure of the Pointing Device and of the Central Unit

FIGS. 3 and 3a present the structure of a local pointing device 501 and a central unit (whether local 601 or remote 601′) respectively according to one particular embodiment of the invention.

The pointing device 501 and the central unit 601, 601′ each comprise a RAM 33, 33′, a processing unit 32, 32′, equipped for example with a processor and driven by a computer program stored in a ROM 31, 31′.

At initialization, the instructions of the computer program code are for example loaded into the RAM 33, 33′ and then executed by the processor of the processing unit 32, 32′ thus enabling the pointing device 501 and the central unit 601/601′ to play their role in the algorithms in FIGS. 2 and 4 (the role of the central unit 601 of the local system being different from that of the central unit 601 of the remote system; the role of the pointing device 501 being different depending on whether it is used with or without the central unit 601′ of the remote system: cf. FIGS. 5 and 6).

FIGS. 3 and 3a illustrate only one particular way among several possible ways of performing the technique of the invention in the pointing device 501 and the central units 601 and 601′. Indeed, in each these entities 501 and 601, the technique of the invention can be carried out equally well:
on a re-programmable computing machine (a PC, a DSP processor, or a microcontroller) executing a program comprising a sequence of instructions, or
on a dedicated computation machine (for example a set of logic gates such as an FPGA or an ASIC or any other hardware module).

If the invention is implanted in a reprogrammable computing machine, then the corresponding program (i.e. the sequence of instructions) could be stored in a storage medium that is detachable (such as for example a floppy disk, a CD ROM or a DVD ROM) or non-detachable, this storage medium being partially or totally readable by a computer or a processor.

### 5.6 Applications

Among numerous examples of use we can cite the following:
using one's own Smartphone from one's main residence to manage (and therefore position) digital objects representing virtual post-it stickers (virtual objects) in the geographical perimeter of the remote system of one's secondary residence;
use one's own Smartphone to place a digital object representing a virtual object (video, a post-it sticker, a telephone number, an address, a password, a shopping list, a list of tasks to be done, security messages, etc) in the geographical perimeter of a remote system;
use one's own tablet (or one's own Smartphone) to point at and interact with digital objects (representing real or virtual objects) of the geographical perimeter of a remote system placed in a remote building;
use one's Smartphone in the office (in one's workplace) to point at a digital object representing a photograph (real object) of one's home and thus be able to switch on the heating in the bathroom;
use one's Smartphone or a tablet from one's home to point at a digital object representing a photo (real object) of one's shop situated downtown and thus be able to turn off one's electrical signboard which is still one;
use a PTZ (pan, tilt, zoom) camera or fixed camera (bulls-eye on ceiling), these cameras currently having sufficient computing processing capacity to request them to provide a given zone of the environment. A PTZ camera will rotate in the direction of the window for example, at the request of the pointing device or a remote Smartphone. A fixed bulls-eye camera could, by image processing, provide only the interested zone, such as the window.

### 5.7 Creation of a New Digital Object in the Remote System

A local pointing device, although it is in the context of the local system, retains the capacity to create a new digital object in the remote system to which it is “transported”.

The creation of a new digital object in the remote system is done for example by using the principle of association of digital objects: I associate a new digital object (which I create and which I describe) with a digital object (representing a virtual or real object) already existing in this remote system. The actions of creating editing, modifying can be activated by means of a specific MMI, or a particular series of gestures. The steps for the creation of a digital object in the remote geographical perimeter are for example the following: a) in a menu, choosing the function of creation; b) describing the new digital object (with its attributes, also called properties); c) to define the position of the new digital object in the remote geographical perimeter, pointing (via the communications channel as described further above) an already existing remote digital object (referenced in the data base of the remote system) and associating the new digital object (“attaching” this object) with it.

In one variant of the creation of a new digital object in the remote system, the pointing device broadcasts a detailed and complete representation of the environment of the remote system (for example a virtual 2D or 3D modeling in a synthetic image displayed on a screen and an MMI of the pointing device). Since this representation contains dimensions, the positions of each digital object and of each (real) element of the environment (walls, doors, windows), i.e. all the information contained in the data base of the remote system. The user can then, by means of an appropriate MMI, manipulate this representation and indicate the exact position of the new object that he wishes to create in the remote system. This an alternative to the step c) mentioned here above, the other steps a) and b) being unchanged.

In another variant of the creation of a new digital object in the remote system, the pointing device takes control of a remote camera (or another apparatus bearing the vision function) of which it can retrieve the images. It is then possible, by treating these images (algorithms, programs, computations, etc) to determine the real coordinates (x, y, z coordinates) in the remote geographical perimeter of an element or a position selected in the image. The coordinates thus determined serve as a position of a new digital object. This is an alternative to the step c) mentioned here above, the other steps a) and b) being unchanged.

### 5.8 Modification of the Position of the Pointing Device in the Remote System (Starting Virtual Position)

The position of the pointing device in the remote system can be modified from the pointing device itself. This is for example done by selecting a digital object known to the remote system and by using its coordinates (known by the central unit of the remote system) as the new position of the pointing device.

In one variant of the modification of the position of the pointing device in the remote system uses “positional digital objects”, i.e. digital objects that can be created, shifted or modified in different ways (by means of an pointing device or an administration tool of the system). This type of object serves to define the position of a pointing device which belongs to a remote system.

In one variant of the modification of the position of the pointing device in a remote system, the local pointing device obtains a detailed graphic representation of the context and the environment around its “transported” position in the remote system. By means of an adapted MMI, the user can drive the shifting of this position, with keys enabling this position to be modified (for example forward, return, left movement or right movement). In return to these actions, the user visually perceives the change in position that has been made.

In another variant of the modification of the position of the pointing device in the remote system, the pointing device takes control of a remote camera (or another unit with the vision function) of which it can retrieve the images. It is then possible, by treating these images (algorithms, programs, computations, etc) to determine the real coordinates (x, y, z) in the remote geographical perimeter, of an element or a position selected in the image. The coordinates thus determined serve as a position of the new digital object.

### 5.9 Variants

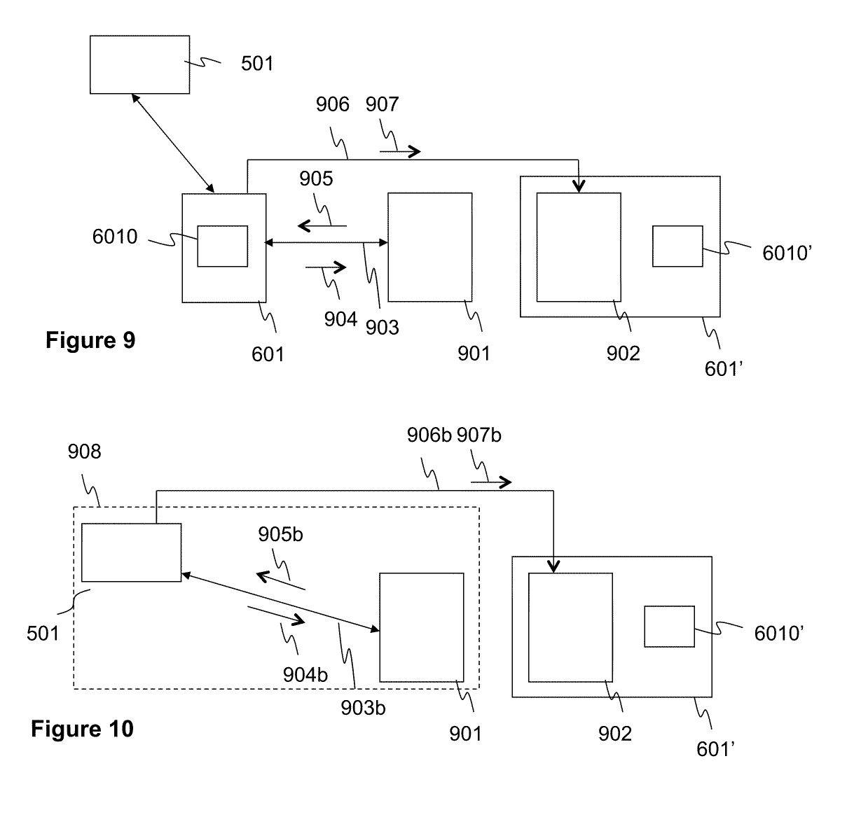

FIG. 9 illustrates a third implementation of the technique of the invention in which, as in the first implementation of FIG. 5, the local pointing device 501 is used with a local tracking device which is the central unit 601 of the local system.

Two functions performed by two distinct units can be distinguished (whereas in the first implementation, they are both performed by the central unit 601′ of the remote system):
an identification device 901, situated in the local geographical perimeter but having access to the remote data base 6010′, carries out the identification of a digital object of the remote geographical perimeter, the position of which is virtually pointed at by the local pointing device 501. 501. This identification is done, on the one hand, according to information on pointing and, secondly, according to the starting virtual position and the starting virtual orientation assigned to the local pointing device 501 in the remote geographical perimeter; and
a control device 902, situated in the remote geographical perimeter and included for example in the central unit 601′ of the remote system, carries out the function of commanding the identified digital object.

In this third implementation, a first communications channel 903 is established between the central unit 601 of the local system (local tracking device) and the identification device 901 (which accesses the remote data base 6010′). On this first communications channel, the local tracking device 601 transmits the pointing information 905 to the identification device 901 and, in the other sense, the identification device 901 transmits the pieces of interaction information 904 to the local tracking device 601. Moreover, a second communications channel 906 is set up between the central unit 601 of the local system (local tracking device) and the control device 902. In this second communications channel, the local tracking device 601 transmits the interaction commands 907.

FIG. 10 illustrates the fourth implementation of the technique of the invention in which, as in the second implementation of FIG. 5, the local pointing device 501 is not used with the central unit 601 of the local system.

As in the third implementation of 1a FIG. 9, the identification device 901 carries out the identification function and the control device 902 carries out the function of commanding the identified digital object.

In this fourth implementation, a first communications channel 903b is set up between the local pointing device 501 (local tracking device) and the identification device 901 (which accesses the remote data base 6010′). On this first communications channel, the local tracking device 501 transmits the pointing information 905b to the identification device 901 and, in the other sense, the identification 901 transmits the information on interactions 904b to the local tracking device 501. Moreover, a second communications channel 906b is set up between the local pointing device 501 (local tracking device) and the control device 902. On this second communications channel, the local tracking device 501 transmits the interaction commands 907b.

In one embodiment, the local pointing device 501 and the identification device 901 are grouped together in a same device referenced 908 in FIG. 10. In other words, the local pointing device 501 can integrate the function of the identification device 901.

1. A method of interaction between at least one digital object representing at least one real or virtual object located in a first geographical perimeter and a pointing device, used in second geographical perimeter distinct from the first geographical perimeter, wherein a unit accesses a first data base referencing one or more digital objects and memorizes a geographical position in the first geographical perimeter for each of these digital objects, the method comprising:
setting up a first communications channel between the unit and a tracking device capable of obtaining pointing information on the pointing device;
receiving, by using the unit, via the first communications channel, pointing information representing a real orientation of the pointing device in the second geographical perimeter; and
identifying, by using the unit, depending firstly on the pointing information received and secondly on a starting virtual position and a starting virtual orientation assigned to the pointing device in the first geographical perimeter, a digital object of the first geographical perimeter, the geographical position of which is virtually pointed at by the pointing device.

2. The method according to claim 1, wherein the method comprises:
transmission to the tracking device, via the first communications channel, of information on interactions relating to interactions available or performed on the identified digital object; and
transmission by the tracking device to a control device, via a second communications channel, of commands on interactions relating to interactions to be made on the identified digital object.

3. The method according to claim 1, wherein a second data base references one or more digital objects representing real or virtual objects located in the second geographical perimeter and memorizes a geographical position in the second geographical perimeter for each of these digital objects, wherein setting up the first communications channel is activated by a detection of an event belonging to the group of events consisting of:
the pointing device points at the position of a particular digital object located in the second geographical perimeter, prompting an automatic activation of a function associated with said particular digital object;
a user, via a man-machine interface of the pointing device, activates a function associated with a digital object that is located in the second geographical perimeter and the position of which is pointed at by the pointing device;
a user, via a man-machine interface of the pointing device, activates a particular function associated with a digital object which is located in the first geographical perimeter and is associated with a digital object located in the second geographical perimeter, and the position of which is pointed at by the local pointing device.

4. The method according to claim 1, wherein setting up the first communications channel is triggered by a detection of an event belonging to the group consisting of the following events:
a user makes a particular gesture with the pointing device;
a user uses a man-machine interface of the tracking device to execute a particular function;
a user uses a man-machine interface of the pointing device to send a particular command to the tracking device;
a user uses a man-machine interface of the pointing device to set up a connection with the tracking device.

5. The method according to claim 1, wherein the starting virtual position and/or the starting virtual orientation are:
predetermined and stored in the unit; or
computed as a function of the characteristics of the first geographical perimeter; or
determined relatively to a digital object of the first geographical perimeter; or
chosen by a user via a man-machine interface.

6. Method according to claim 1, wherein the method comprises providing a user, via a man-machine interface of the pointing device, with guidance information on a current virtual position and a current virtual orientation determined for the pointing device in the first geographical perimeter.

7. Method according to claim 1, wherein the method comprises creating at least one group of associated digital objects, each group associating at least one digital object of the second geographical perimeter with at least one digital object of the first geographical perimeter

8. Method according to claim 1, wherein the method comprises creating a new digital object of the first geographical perimeter.

9. (canceled)

10. A computer-readable and non-transient storage medium storing a computer program comprising a set of instructions executable by a computer to implement method of interaction between at least one digital object representing at least one real or virtual object located in a first geographical perimeter and a pointing device, used in second geographical perimeter distinct from the first geographical perimeter, wherein a unit accesses a first data base referencing one or more digital objects and memorizes a geographical position in the first geographical perimeter for each of these digital objects, the method comprising:
setting up a first communications channel between the unit and a tracking device capable of obtaining pointing information on the pointing device;
receiving, by using the unit, via the first communications channel, pointing information representing a real orientation of the pointing device in the second geographical perimeter; and
identifying, by using the unit, depending firstly on the pointing information received and secondly on a starting virtual position and a starting virtual orientation assigned to the pointing device in the first geographical perimeter, a digital object of the first geographical perimeter, the geographical position of which is virtually pointed at by the pointing device.

11. A unit for implementing a method of interaction between at least one digital object representing at least one real or virtual object located in a first geographical perimeter and a pointing device, used in a second geographical perimeter distinct from the first geographical perimeter,
the unit accessing a first data base referencing one or more digital objects and memorizing a position in the first geographical perimeter for each of these digital objects, the unit being configured to determine whether the position of one of the digital objects is being pointed at the given pointing device, according to the positions of the digital objects in the first geographical perimeter and from information on the position and orientation of a given pointing device,
the unit comprising:
means for setting up a communications channel with a tracking device, capable of obtaining information on pointing of the pointing device;
means for receiving, via the communications channel, pointing information representing a real orientation of the pointing device in the second geographical perimeter;
means for identifying, as a function firstly of received pointing information and secondly of a starting virtual position and a starting virtual orientation assigned to the pointing device in the first geographical perimeter, a digital object of the first geographical perimeter, the position of which is pointed at virtually by the pointing device.

12. The unit according to claim 11, wherein the unit comprises means for transmission to the local tracking device, via the communications channel, of information on interactions relative to available interactions or interactions made on the identified digital object.
